(19) United States
(12) Patent Application Publication
(10) Pub. No.: US 2026/0136172 A1
(43) Pub. Date: May 14, 2026

(54) MACHINE LEARNING PROCESSING CAPABILITY MANAGEMENT

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US)

(21) Appl. No.: 18/945,239

(22) Filed: Nov. 12, 2024

(51) Int. Cl. H04W 8/24; H04W 24/02

(52) U.S. Cl. CPC H04W 8/24; H04W 24/02

(57) ABSTRACT

Various aspects of the present disclosure generally relate to wireless communication. In some aspects, a user equipment (UE) may receive configuration information indicating that the UE is to report a number of machine learning processing units (MPUs) for each of a plurality of machine learning (ML) operations. The UE may transmit data indicating the number of MPUs for each of the plurality of ML operations and a maximum number of MPUs supported by the UE. Numerous other aspects are described.

### FIELD OF THE DISCLOSURE

Aspects of the present disclosure generally relate to wireless communication and specifically relate to techniques, apparatuses, and methods associated with machine learning processing capability management.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be individually or collectively configured to receive configuration information indicating that the UE is to report a number of machine learning processing units (MPUs) for each of a plurality of machine learning (ML) operations. The one or more processors may be individually or collectively configured to transmit data indicating the number of MPUs for each of the plurality of ML operations and a maximum number of MPUs supported by the UE.

Some aspects described herein relate to a network node for wireless communication. The network node may include one or more memories and one or more processors coupled to the one or more memories. The one or more processors may be individually or collectively configured to receive data indicating a number of MPUs for each of a plurality of ML operations and a maximum number of MPUs supported by a UE. The one or more processors may be individually or collectively configured to transmit configuration information indicating that the UE is to execute a subset of the plurality of ML operations, where the number of MPUs associated with the subset does not exceed the maximum number of MPUs.

Some aspects described herein relate to a method of wireless communication performed by UE. The method may include receiving configuration information indicating that the UE is to report a number of MPUs for each of a plurality of ML operations. The method may include transmitting data indicating the number of MPUs for each of the plurality of ML operations and a maximum number of MPUs supported by the UE.

Some aspects described herein relate to a method of wireless communication performed by a network node. The method may include receiving data indicating a number of MPUs for each of a plurality of ML operations and a maximum number of MPUs supported by a UE. The method may include transmitting configuration information indicating that the UE is to execute a subset of the plurality of ML operations, where the number of MPUs associated with the subset does not exceed the maximum number of MPUs.

Some aspects described herein relate to a non-transitory computer-readable medium that stores a set of instructions for wireless communication by a UE. The set of instructions, when executed by one or more processors of the UE, may cause the UE to receive configuration information indicating that the UE is to report a number of MPUs for each of a plurality of ML operations. The set of instructions, when executed by one or more processors of the UE, may cause the UE to transmit data indicating the number of MPUs for each of the plurality of ML operations and a maximum number of MPUs supported by the UE.

Some aspects described herein relate to a non-transitory computer-readable medium that stores a set of instructions for wireless communication by a network node. The set of instructions, when executed by one or more processors of the network node, may cause the network node to receive data indicating a number of MPUs for each of a plurality of ML operations and a maximum number of MPUs supported by a UE. The set of instructions, when executed by one or more processors of the network node, may cause the network node to transmit configuration information indicating that the UE is to execute a subset of the plurality of ML operations, where the number of MPUs associated with the subset does not exceed the maximum number of MPUs.

Some aspects described herein relate to an apparatus for wireless communication. The apparatus may include means for receiving configuration information indicating that a UE is to report a number of MPUs for each of a plurality of ML operations. The apparatus may include means for transmitting data indicating the number of MPUs for each of the plurality of ML operations and a maximum number of MPUs supported by the UE.

Some aspects described herein relate to an apparatus for wireless communication. The apparatus may include means for receiving data indicating a number of MPUs for each of a plurality of ML operations and a maximum number of MPUs supported by a UE. The apparatus may include means for transmitting configuration information indicating that the UE is to execute a subset of the plurality of ML operations, where the number of MPUs associated with the subset does not exceed the maximum number of MPUs.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example architecture of a functional framework for radio access network (RAN) intelligence enabled by data collection, in accordance with the present disclosure.

FIG. 4 depicts an example of various machine learning (ML) operations and example ML processing unit (MPU) values associated with a user equipment (UE), in accordance with the present disclosure.

FIG. 5 is a diagram of an example associated with machine learning processing capability management, in accordance with the present disclosure.

FIG. 6 is a diagram illustrating an example of MPU occupancy time, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Artificial intelligence (AI) and/or machine learning (ML) (AI/ML) models may be used to enhance various aspects of wireless communications. For example, some network devices may leverage AI/ML models and historical data to predict future network behavior, such as signal interference and channel state information (CSI). AI/ML models may be capable of handling complex, high-dimensional features of wireless environments, which are often too intricate for basic analytical models to accurately capture. With the expansion of use cases for AI and ML in network wireless communications, a user equipment (UE) may be expected to be capable of performing multiple ML operations to address tasks such as interference prediction, beam management, and positioning enhancement.

However, UEs are often constrained in ML capabilities by limited resources, such as computational, memory, and power resources. These limited resources may be shared across different AI/ML models running on the UE. As such, UEs are not usually capable of running multiple or all ML operations simultaneously, which may lead to difficulties in effectively managing the operation of multiple AI/ML models, may result in latency with respect to obtaining output from an AI/ML model, and the like. The capability of a UE to perform ML operations concurrently varies, for example, based on the particular ML operations being performed, the complexity of the individual AI/ML models and the tier of the UE, with higher-tier UEs having the resources to run more ML operations simultaneously as compared to lower-tier UEs. ML operations may refer to operations performed in association with an AI/ML model, as described herein.

Various aspects relate generally to enhancing wireless communications via ML processing capability management. Some aspects more specifically relate to a UE and a network node coordinating to determine and report the resource requirements for different ML operations and to schedule ML operations in accordance with the resource requirements and with the resource restrictions of the UE. In some aspects, a UE may receive configuration information indicating that the UE is to report a number of ML processing units (MPUs) required for each ML operation the UE is capable of performing, and the UE may subsequently transmit data that indicates the number of MPUs for each ML operation along with a maximum number of MPUs supported by the UE. For example, along with the maximum number of MPUs, the UE may transmit information indicating MPUs associated with each of interference prediction, beam management, and positioning ML operations, among other examples.

In some aspects, a network node may receive, from the UE, data indicating a number of MPUs for each of multiple ML operations capable of being performed by a UE, along with a maximum number of MPUs supported by the UE. For example, along with the maximum number of MPUs, the network node may receive information indicating MPUs associated with each of interference prediction, beam management, and positioning ML operations, among other examples. The network node may then transmit configuration information indicating that the UE is to execute one or more of the ML operations capable of being performed by the UE. The number of MPUs associated with the one or more ML operations may not exceed the maximum number of MPUs supported by the UE, such that the network does not configure the UE to perform simultaneous ML operations that would exceed the maximum number of MPUs.

Particular aspects of the subject matter described in this disclosure can be implemented to realize one or more of the following advantages. By the UE transmitting data indicating the number of MPUs associated with each ML operation as well as the maximum number of MPUs effectively supported by the UE, and by the network node transmitting configuration information using the number of MPUs associated with each ML operation and the maximum number of MPUs supported by the UE, the described techniques may enable the network to tailor the scheduling and configuration of ML operations within the resource limitations of the UE. For example, this enables the network to schedule ML operations within the UE's capabilities, which may reduce the likelihood of overburdening the UE and may optimize ML operations with respect to available computational, memory, and power resources. In this way, UEs may take advantage of advanced AI/ML techniques capable of improving network performance while conserving processing resources, memory resources, network resources, power resources, and/or the like.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or AI/ML, among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

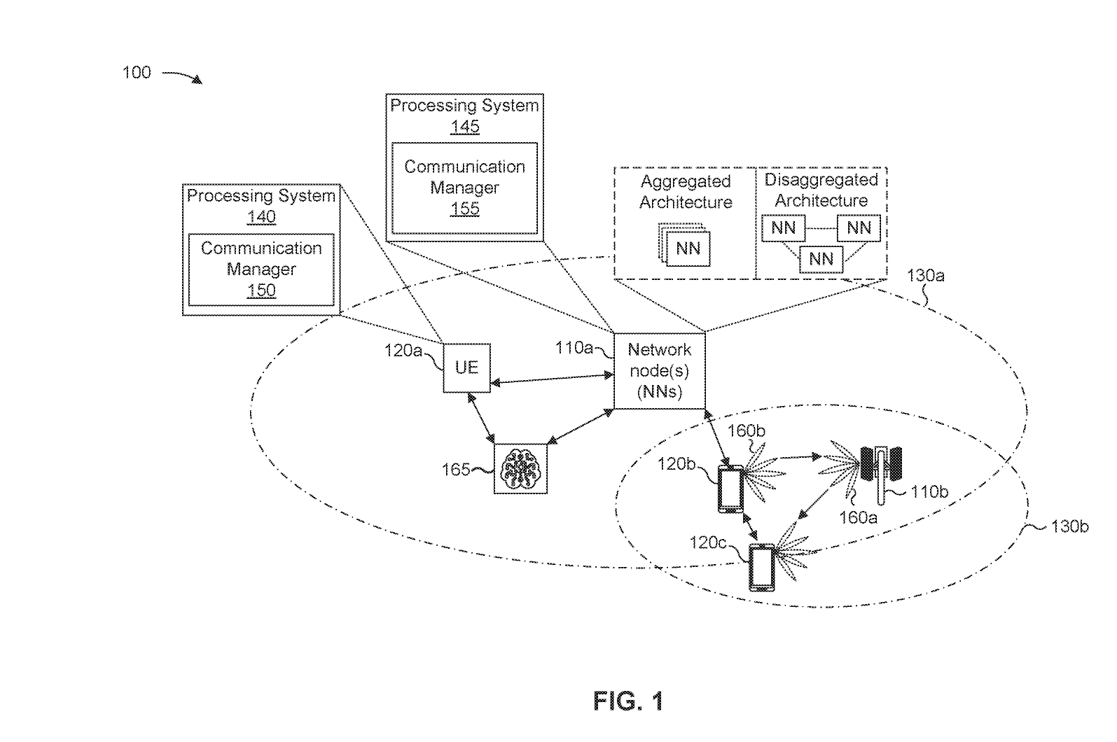

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

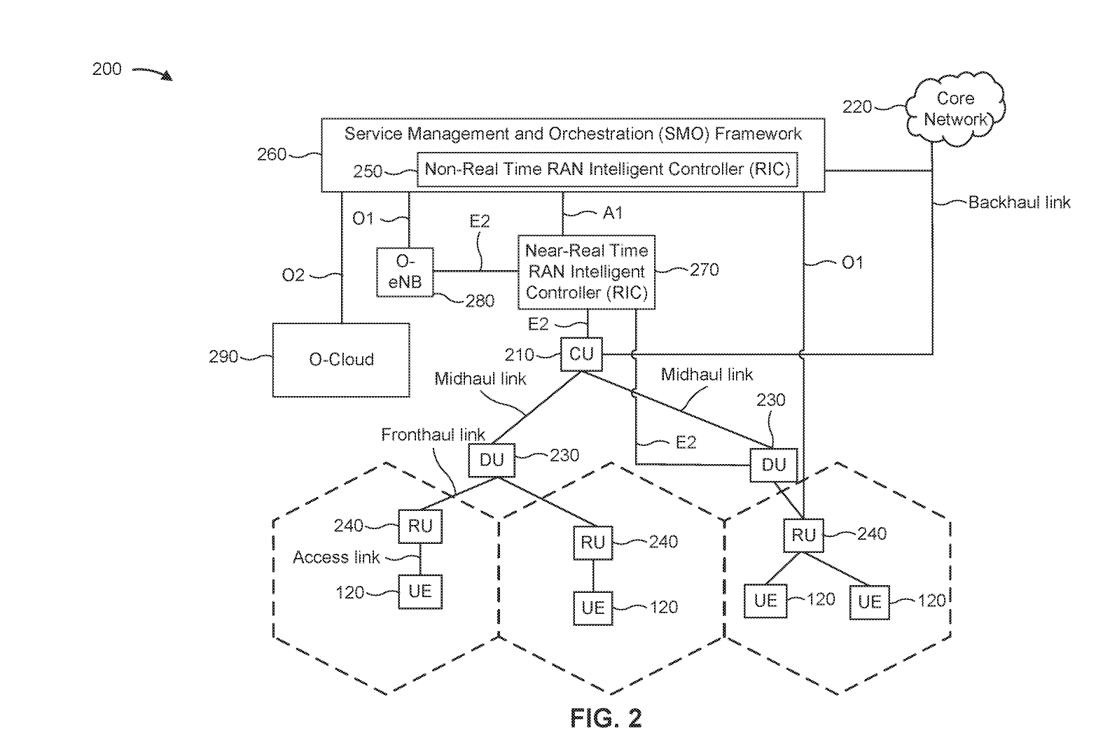

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an AI program (for example, referred to herein as an “AI/ML model”), such as a program that includes an AI/ML model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive configuration information indicating that the UE is to report a number of MPUs for each of a plurality of ML operations; and transmit data indicating the number of MPUs for each of the plurality of ML operations and a maximum number of MPUs supported by the UE. Additionally, or alternatively, the communication manager 150 may perform one or more other operations described herein.

In some aspects, the network node 110 may include a communication manager 155. As described in more detail elsewhere herein, the communication manager 155 may receive data indicating a number of MPUs for each of a plurality of ML operations and a maximum number of MPUs supported by a UE; and transmit configuration information indicating that the UE is to execute a subset of the plurality of ML operations, wherein the number of MPUs associated with the subset does not exceed the maximum number of MPUs. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

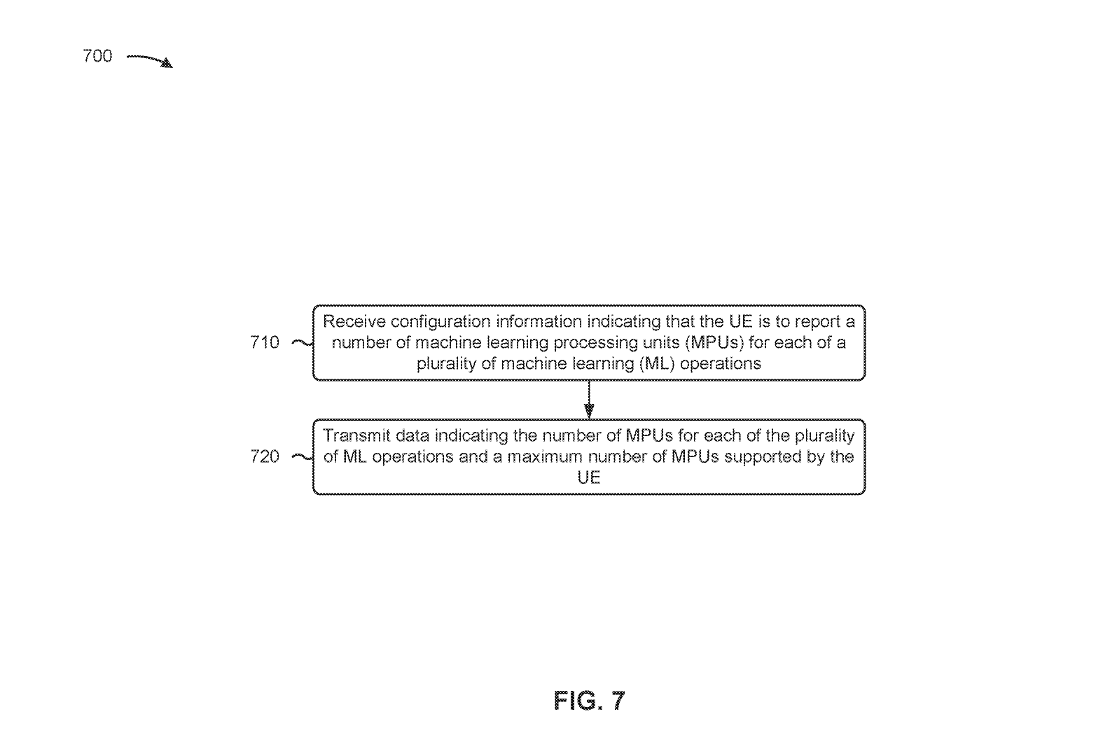

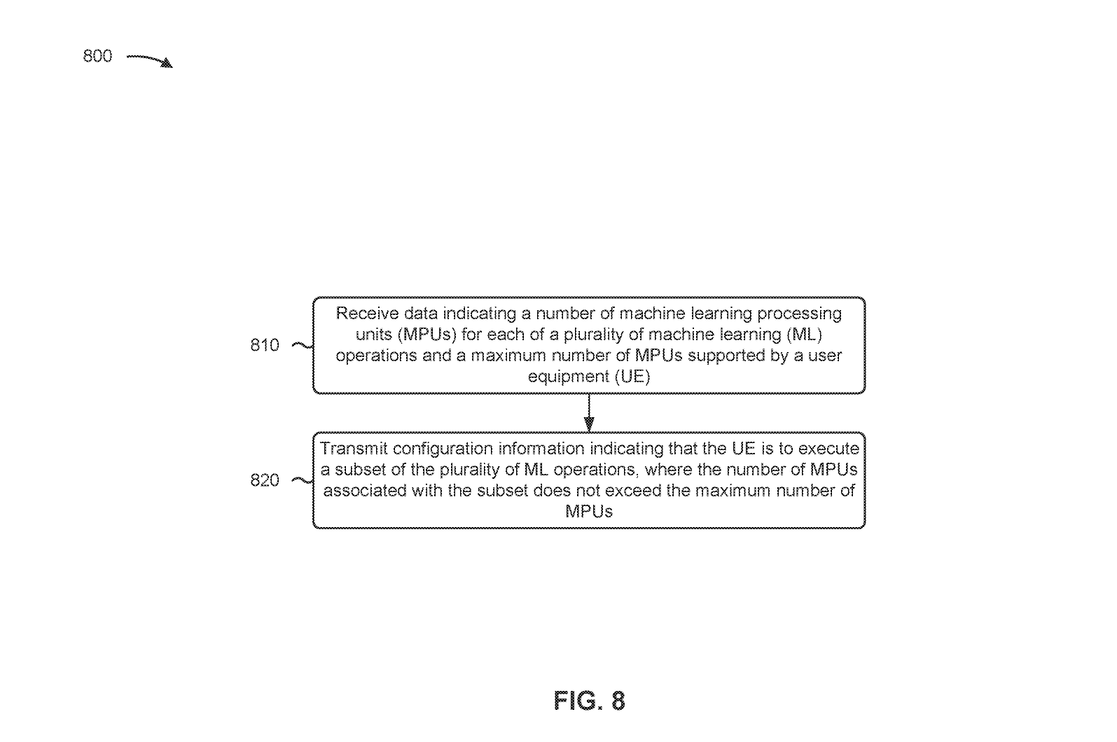

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with machine learning processing capability management, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

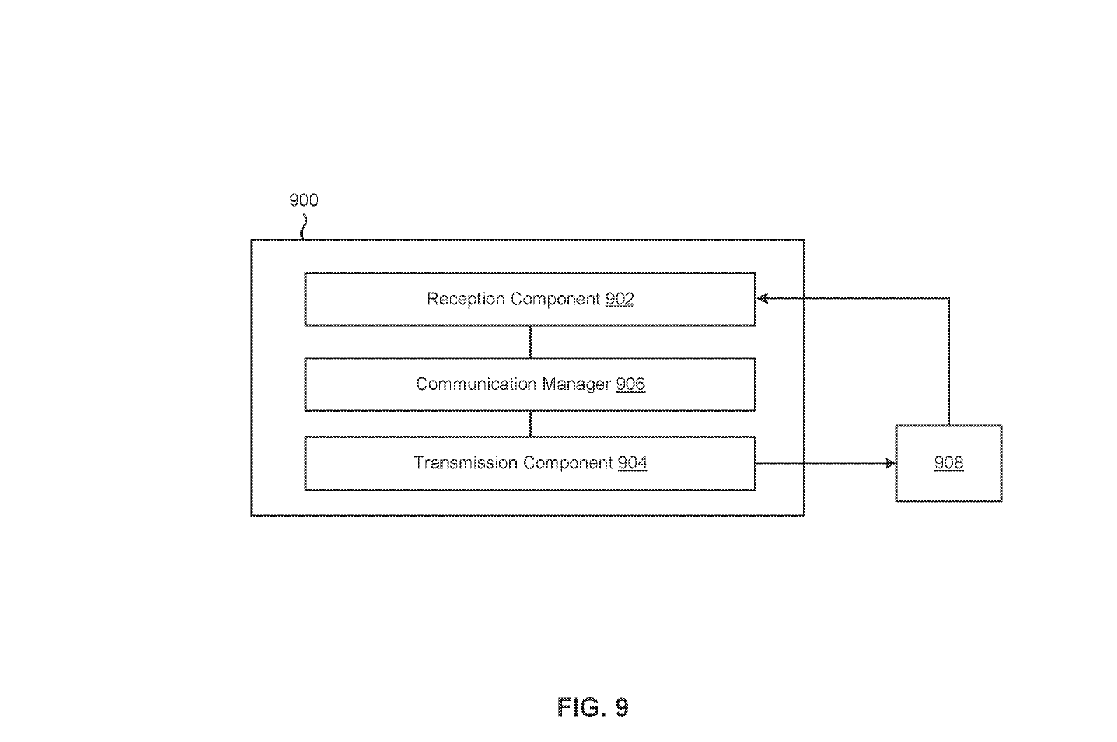

In some aspects, the UE (e.g., UE 120) includes means for receiving configuration information indicating that the UE is to report a number of MPUs for each of a plurality of ML operations; and/or means for transmitting data indicating the number of MPUs for each of the plurality of ML operations and a maximum number of MPUs supported by the UE. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

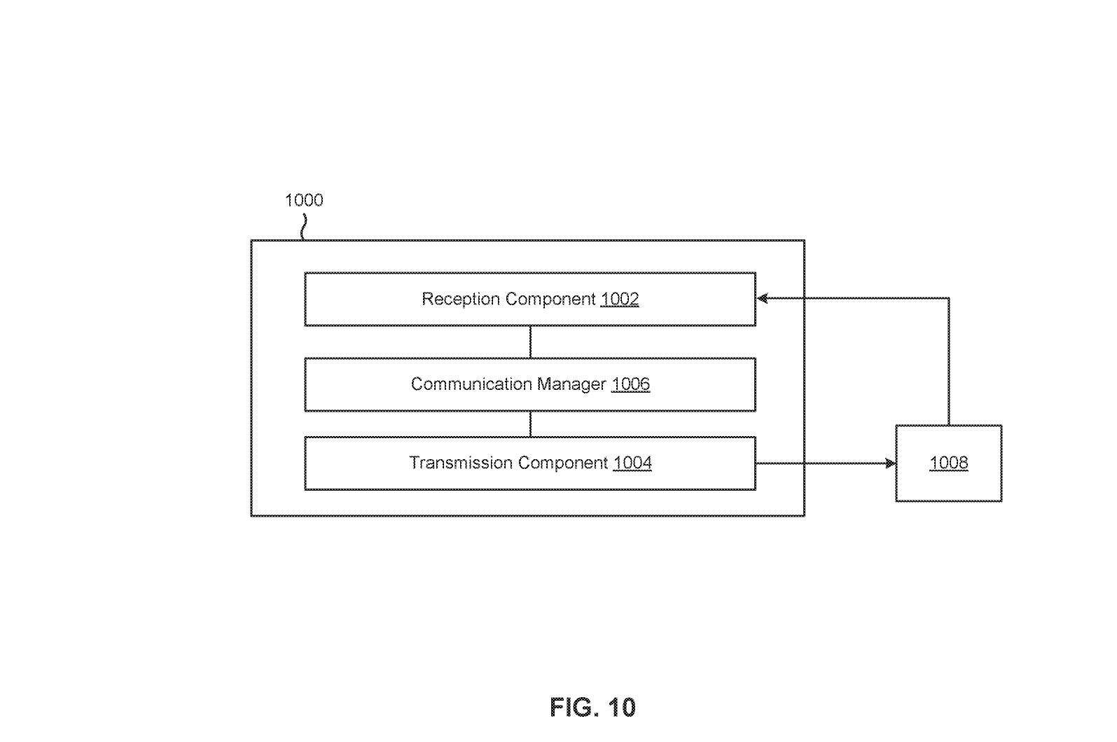

In some aspects, the network node (e.g., network node 110) includes means for receiving data indicating a number of MPUs for each of a plurality of ML operations and a maximum number of MPUs supported by a UE; and/or means for transmitting configuration information indicating that the UE is to execute a subset of the plurality of ML operations, wherein the number of MPUs associated with the subset does not exceed the maximum number of MPUs. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

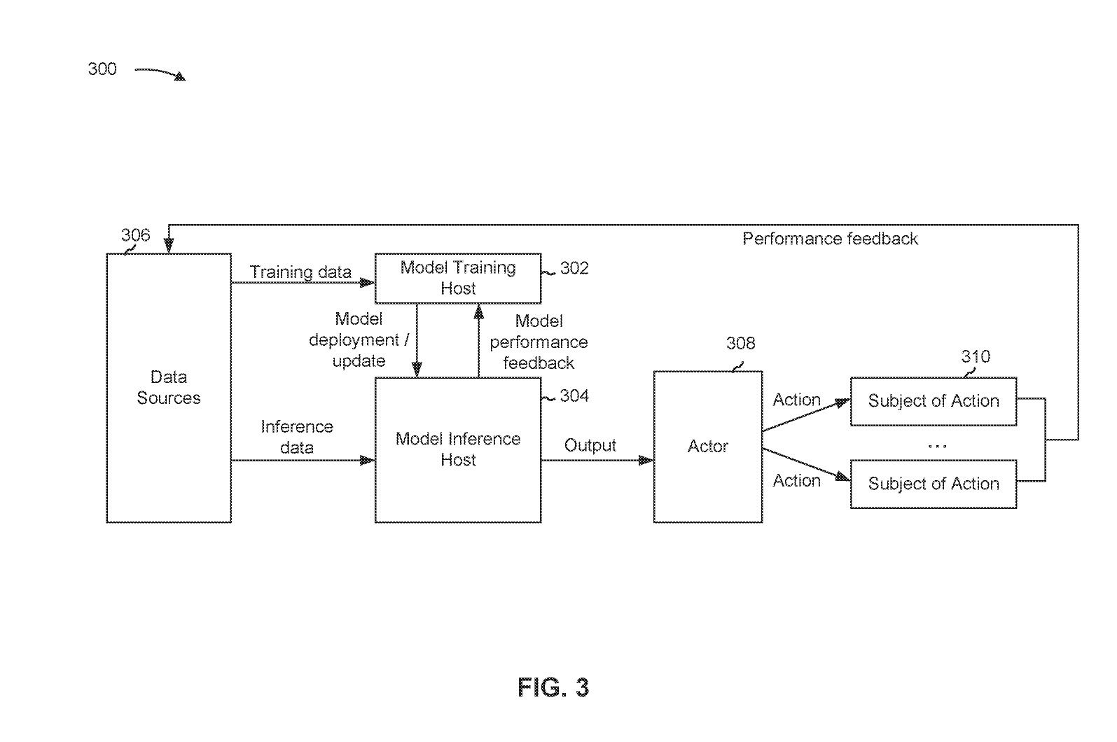

FIG. 3 is a diagram illustrating an example architecture 300 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 300, a functional framework for RAN intelligence may include multiple logical entities, such as a model training host 302, a model inference host 304, data sources 306, and an actor 308.

The model inference host 304 may be configured to run an AI/ML model based on inference data provided by the data sources 306, and the model inference host 304 may produce an output (e.g., a prediction) with the inference data input to the actor 308. The actor 308 may be an element or an entity of a core network or a RAN. For example, the actor 308 may be a UE, a network node, base station (e.g., a gNB), a CU, a DU, and/or an RU, among other examples. In addition, the actor 308 may also depend on the type of tasks performed by the model inference host 304, type of inference data provided to the model inference host 304, and/or type of output produced by the model inference host 304. For example, if the output from the model inference host 304 is associated with position determination, the actor 308 may be a UE, a DU or an RU. In some examples, the model inference host 304 may be hosted on the actor 308. For example, a UE may be the actor 308 and may host the model inference host 304. In some aspects, a UE (e.g., the actor 308) may be a data source 306. For example, the UE may perform a measurement (e.g., an NR measurement), may input the measurement to the AI/ML model at the model inference host 304 (or may provide the measurement to the model inference host 304), and may act based on an output of the AI/ML model (e.g., the UE, after performing inference using an interference prediction AI/ML model, may report predicted interference to a network node).

After the actor 308 receives an output from the model inference host 304, the actor 308 may determine whether to act based on the output. For example, if the actor 308 is a UE and the output from the model inference host 304 is associated with position information, the actor 308 may determine whether to report the position information and/or reconfigure a beam, among other examples. If the actor 308 determines to act based on the output, in some examples, the actor 308 may indicate the action to at least one subject of action 310.

The data sources 306 may also be configured for collecting data that is used as training data for training an AI/ML model or as inference data for feeding an AI/ML model inference operation. For example, the data sources 306 may collect data from one or more core network and/or RAN entities, which may include the actor 308 or the subject of action 310, and provide the collected data to the model training host 302 for AI/ML model training. In some aspects, the model training host 302 may be co-located with the model inference host 304 and/or the actor 308. For example, the actor 308 or the subject of action 310 may provide performance feedback associated with the beam configuration to the data sources 306, where the performance feedback may be used by the model training host 302 for monitoring or evaluating the AI/ML model performance, such as whether the output (e.g., prediction) provided to the actor 308 is accurate. In some examples, if the output provided by the actor 308 is inaccurate (or the accuracy is below an accuracy threshold), then the model training host 302 may determine to modify or retrain the AI/ML model used by the model inference host, such as via an AI/ML model deployment/update.

While both inference and training of AI/ML models are described herein, in some aspects, another operational mode associated with ML operations includes monitoring results of ML operations. For example, a RAN entity, such as a UE or network node, may monitor results of ML inference to identify when an action should be taken (e.g., in response to a triggering event and/or a threshold being met, among other examples). As used herein, ML operations may be associated with one of three operational modes. An inference operational mode associated with execution of an AI/ML model (e.g., predicting a position of a UE), a training operational mode associated with training an AI/ML model (e.g., training a positioning AI/ML model to predict the position of the UE), or a monitoring operational mode associated with analyzing AI/ML model inference results (e.g., monitoring the predicted position of a UE over time to identify when a condition is met, such as the UE being predicted to be out of range of one network node and/or within range of another network node).

In some aspects, different ML operational modes may use difference resources, including different computational (e.g., processor), memory, and/or power resources for the model training host 302, the model inference host 304, and/or the actor 308. To quantify the resource requirements of ML operations, the concept of an MPU is introduced. An MPU may represent a unit of computational, memory, and/or power resources, and the exact amount of resources need not be explicitly defined. For example, different network devices (e.g., different network nodes and/or different UEs) may have defined MPUs differently, enabling device manufacturers to obfuscate the actual resource requirements and capabilities of the network devices while still providing abstracted values useful for configuration and scheduling of ML operations across a network. While MPUs are described herein as representing aggregate computational, memory, and/or power resources, in some aspects, separate MPUs could be substituted for individual resources (e.g., a computational MPU, a memory MPU, a power MPU, and/or the like). Additionally, or alternatively, while described as being a representative value, MPUs could be explicitly defined with specific values (e.g., processor clock/cache values, memory storage and/or bandwidth values, and/or specific power values, among other examples).

As described further herein, MPUs enable devices to specify requirements and capabilities for various ML operations, including inference, training, and monitoring operations associated with various AI/ML models. For example, a UE may be capable of allocating 10 MPUs for simultaneous ML operations, and given specific MPU values reported for various ML operations, a network node may configure and schedule ML operations for the UE so as not to exceed 10 MPUs.

As indicated above, FIG. 3 is provided as an example. Other examples may differ from what is described with regard to FIG. 3.

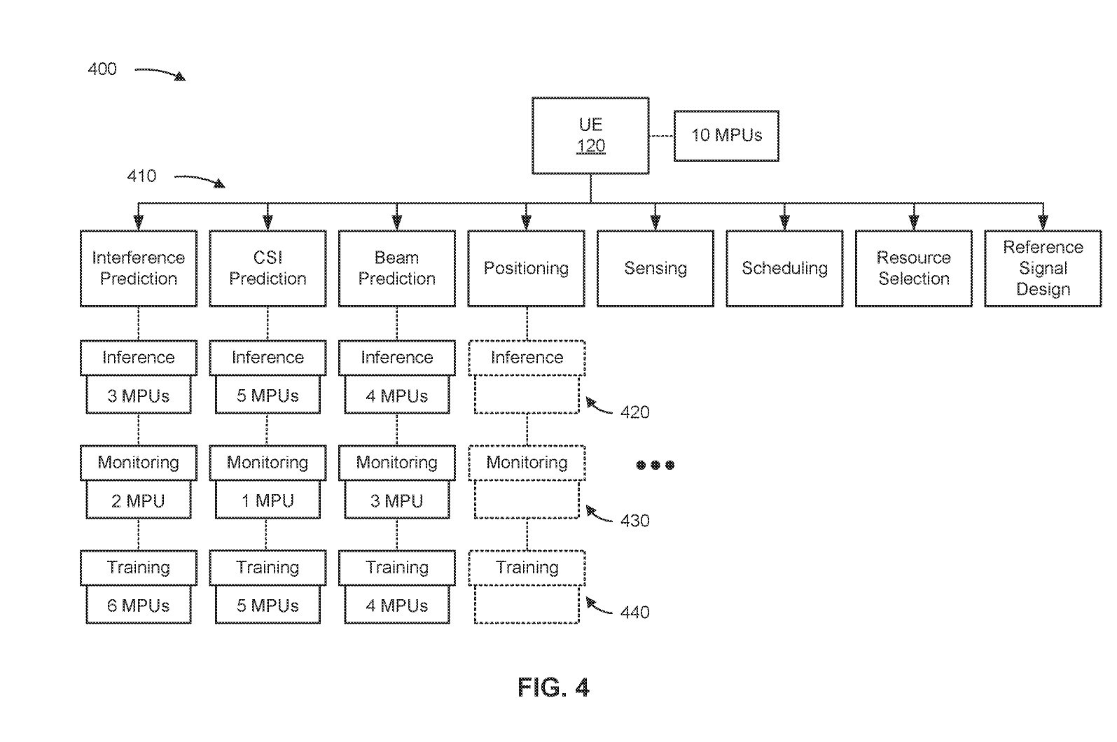

FIG. 4 depicts an example 400 of various ML operations 410 and example MPU values associated with a UE (e.g., UE 120), in accordance with the present disclosure.

As shown in FIG. 4, the UE 120 may be capable of performing multiple ML operations 410, including interference prediction, CSI prediction, beam prediction, positioning, sensing, scheduling, resource selection, and reference signal design, among other examples. For the example, 400, the UE 120 has a total of 10 MPUs available, which represents the amount of resources the UE 120 has available for simultaneous ML operations. In other examples, the UE 120 may have a different number of MPUs.

As one example, interference prediction operations may use an AI/ML model to predict future signal interference levels in a wireless network to improve communication reliability and quality. In the depicted example 400, the interference prediction may require different MPU allocations based on the operational mode. The example operational modes include an inference operational mode associated with AI/ML model execution, a training operational mode associated with AI/ML model training, and a monitoring operational associated with analyzing AI/ML model results. The different number of MPUs per operational mode enable the UE to identify different resource requirements that might be associated with different tasks (e.g., training, monitoring, and inference). For example, with respect to interference prediction at the UE, inference 420 may use 3 MPUs, monitoring 430 may use 2 MPUs, and training 440 may use 6 MPUs.

As another example, CSI prediction operations may use an AI/ML model to predict future CSI to enhance data transmission efficiency and accuracy. CSI prediction at the UE 120 may use 5 MPUs for inference 420, 1 MPU for monitoring 430, and 5 MPUs for training 440.

As another example, beam prediction operations may use an AI/ML model to predict optimal beamforming directions and/or weights to improve signal strength and coverage. Beam prediction at the UE 120 may use 4 MPUs for inference 420, 3 MPUs for monitoring 430, and 4 MPUs for training 440.

As another example, positioning operations may use an AI/ML model to determine a precise location of the UE 120 to aid in detecting potential interference, coverage gaps, and/or handover requirements, and may also be used for navigation and location-based services. Sensing operations may use an AI/ML model to detect and/or measure various reference signals, network parameters, and/or environmental conditions to optimize network performance, which may involve operations such as detecting signal strength variations, interference levels, and/or latency metrics. Scheduling operations may use an AI/ML model to allocate resources and/or schedule transmissions to maximize network efficiency and throughput, e.g., in a manner designed to ensure that data transmissions are optimally placed in time and frequency to avoid congestion and increase overall throughput. Resource selection operations may use an AI/ML model to choose the optimal network resources (e.g., frequency bands, channels, and/or the like) in a manner designed to ensure efficient communication, which may include analyzing parameters such as signal quality and network congestion to select the best available resources. Reference signal design operations may use an AI/ML model to design reference signals to improve, for example, synchronization and channel estimation accuracy in the network, which may involve creating signal patterns that enhance the accuracy of data transmission and signal reception. Each of the foregoing examples may also be associated with MPU values for inference 420, monitoring 430, and training 440.

As described further herein, the UE 120 may provide the MPU values, including the 10 MPU maximum, to a network node, which may use the MPU values to manage and allocate the various ML operations 410 to avoid exceeding the 10 MPU maximum. This enables the network to dynamically reconfigure ML operations based on the available MPUs in a manner designed to optimize performance and resource utilization.

As indicated above, FIG. 4 is provided as an example. Other examples may differ from what is described with regard to FIG. 4.

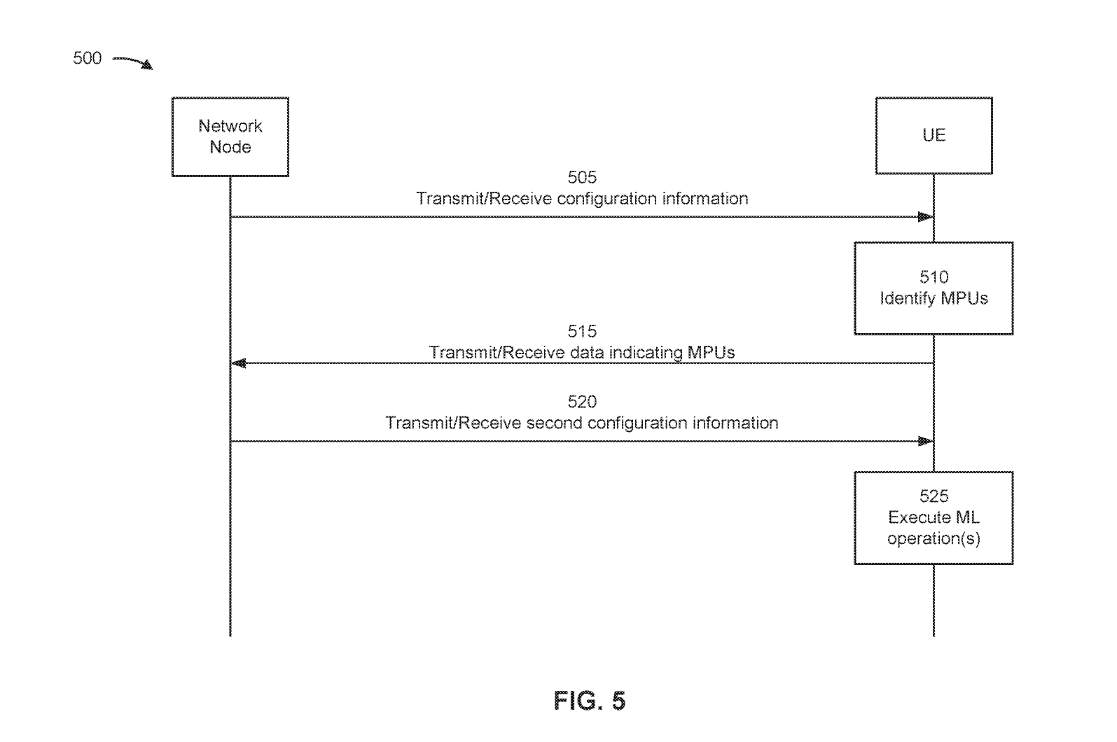

FIG. 5 is a diagram of an example 500 associated with machine learning processing capability management, in accordance with the present disclosure. As shown in FIG. 5, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 5.

As shown by reference number 505, the network node may transmit, and the UE may receive, configuration information. In some aspects, the UE may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE is to report a number of MPUs for each of multiple ML operations. The configuration information may also indicate that the UE is to report a maximum number of MPUs supported by the UE.

The UE may configure itself based at least in part on the configuration information. In some aspects, the UE may be configured to perform one or more operations described herein based at least in part on the configuration information. For example, the UE may be configured determine, identify, or access stored information indicating, the number of MPUs the UE supports per each of multiple ML operations and/or the maximum number of MPUs supported by the UE based on receiving the configuration information.

As shown by reference number 510, the UE may identify MPUs associated with ML operations the UE is capable of performing. As described herein, the ML operations may include ML operations associated with interference prediction, CSI prediction, CSI compression, beam prediction, positioning, sensing, scheduling, resource selection, and/or reference signal design, among other examples.

In some aspects, the number of MPUs for an ML operation is based at least in part on an operational mode associated with the ML operation. Operational modes may include, by way of example, an inference operational mode associated with ML execution, a training operational mode associated with ML training, and/or a monitoring operational associated with analyzing ML results, among other examples. The different number of MPUs per operational mode enable the UE to identify different resource requirements that might be associated with different tasks (e.g., training, monitoring, and inference).

In some aspects, an ML operation may include a combination of multiple AI/ML model functionalities. For example, a single AI/ML model may be trained to perform multiple tasks, instead of only a single task. As one specific example, a UE may train a single AI/ML model that utilizes historical CSI-RS measurements to perform beam prediction and CSI prediction simultaneously. In this situation, a single ML operation may be associated with both beam prediction and CSI prediction, and the UE may identify one MPU value associated with both beam prediction and CSI prediction. In some implementations, the MPU value for the combined beam prediction and CSI prediction ML operation may be less than a sum of the MPU values for the individual AI/ML model functionalities, e.g., a sum of a CSI prediction MPU value and a beam prediction MPU value may be greater than the combined beam prediction and CSI prediction MPU value. In some aspects, having multiple AI/ML model functionalities associated with ML operations may provide greater flexibility in the scheduling and configuration of the ML operations.

In some aspects, multiple ML operations may be associated with the same AI/ML model functionality but have a different number of MPUs. For example, a UE may have multiple AI/ML models trained to predict interference in different environments. Each AI/ML model may be associated with interference prediction but have different MPUs based on a difference in the environment associated with the UE. As another example, a spatial-temporal beam prediction AI/ML model may require more MPUs than a temporal-only or a spatial-only beam prediction AI/ML model.

In some aspects, each ML operation, or each MPU value, may be associated with an AI/ML model identifier (AI/ML model ID) and/or an AI/ML model functionality. As provided herein, ML operations may make use of multiple AI/ML models, and some AI/ML models may be associated with multiple AI/ML model functionalities. AI/ML model IDs and/or functionalities may enable the UE to more specifically identify particular AI/ML models and AI/ML model functionalities that are associated with particular ML operations and MPU values. For example, in a situation where multiple AI/ML models may perform the same AI/ML model functionality (e.g., interference prediction), the AI/ML models may be separately identified by respective AI/ML model IDs and/or separately defined AI/ML model functionalities. Specific AI/ML model IDs and/or functionalities may enable the UE and network node to maintain organized information about the exact AI/ML capabilities of a UE and the corresponding MPU values for the specific capabilities.

In some aspects, the UE may identify input and/or output complexity values associated with inputs and/or outputs of one or more ML operations. In this situation, the UE may identify the number of MPUs for an ML operation based at least in part on the input complexity value, the output complexity value, and/or a base complexity value associated with an AI/ML model used in the ML operation. For example, AI/ML models may have different resource requirements based on the number of inputs and/or outputs. As the number of input measurements and/or output predictions of a given AI/ML model increase, the complexity of running the AI/ML model increases, which may lead to an increased MPU value. In feed-forward AI/ML model architectures, more input measurements can increase the number of input branches to the AI/ML model, which also requires additional resources and may lead to an increased MPU value. In long short-term memory AI/ML model architectures, more input measurements increase the number of cycles to run the AI/ML model, which may lead to an increased MPU value.

In some aspects, the different resource requirements of AI/ML models may be represented by complexity values, such as an input complexity value and an output complexity value. An AI/ML model may also have a base complexity value regardless of the input/output complexity, and a combined ML complexity may be represented by the based complexity value, plus the input complexity value multiplied by the number of inputs, plus the output complexity value multiplied by the number of outputs. The combined complexity value may correspond to an MPU value for an ML operation that uses the AI/ML model.

In some aspects, ML operations and corresponding MPU values may be associated with an MPU occupancy time. The MPU occupancy time identifies an amount of time the MPUs associated with an ML operation are in use, occupied, or otherwise allocated. For example, an MPU occupancy time may be defined by a temporal separation between an earliest input and a latest output associated with the corresponding ML operation. In this situation, the UE may have a particular number of MPUs allocated for a duration of time that includes gathering inputs (e.g., reference signals for interference prediction), performing inference using an AI/ML model (e.g., using an interference prediction AI/ML model to predict network interference), and reporting a result of the inference (e.g., transmitting a report indicating the interference prediction). The MPU occupancy time may have different start and end times depending on implementation, configuration, and/or standardization. As examples, MPU occupancy time may start at the last input measurement (e.g., instead of the first input measurement) or the start of inference, and may end after inference ends, among other examples.

As shown by reference number 515, the UE may transmit, and the network node may receive, data indicating the number of MPUs for each of the multiple ML operations and a maximum number of MPUs supported by the UE. In some aspects, the data indicating the number of MPUs may also include data indicating AI/ML model IDs and/or functionalities and data indicating MPU occupancy time associated with the ML operations. As described herein, the network node may use the data indicating the number of MPUs and the maximum number of MPUs to configure and schedule ML operations for the UE.

As shown by reference number 520, the network node may transmit, and the UE may receive, second configuration information that configures the UE to execute one or more ML operations. For example, the second configuration information may schedule ML operations to be performed by the UE in a manner designed to help ensure the MPUs of the scheduled ML operations do not exceed the maximum number of MPUs reported by the UE. In some aspects, the network node might analyze the MPU occupancy times to avoid conflicts where multiple ML operations might simultaneously demand MPUs that exceed the maximum MPUs reported by the UE. In some situations, the network node might be aware of network conditions and available network resources beyond what the UE is aware of, which may enable the network node to schedule ML operations more effectively than the UE alone.

As shown by reference number 525, the UE may execute ML operations. For example, the ML operations may be executed in accordance with the second configuration information. In some aspects, the second configuration information indicates a schedule and/or triggering conditions, among other examples, that indicate when the UE is to execute ML operations and which ML operations to execute. By executing ML operations in accordance with the second configuration information, the UE is able to execute ML operations without exceeding the maximum number of MPUs.

As indicated above, FIG. 5 is provided as an example. Other examples may differ from what is described with regard to FIG. 5.

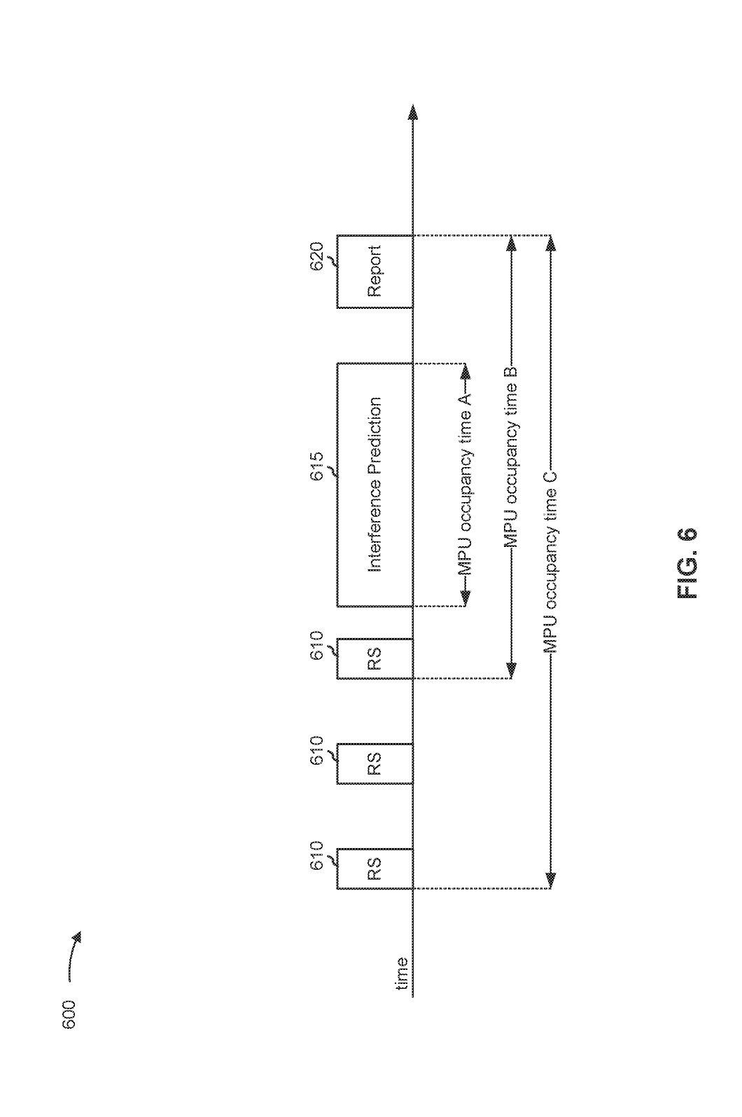

FIG. 6 is a diagram illustrating an example 600 of MPU occupancy time, in accordance with the present disclosure. As shown in FIG. 6, various events are depicted along a time axis for a particular example involving an interference prediction ML operation. Reference signals 610, the measurements of which can be used as input for an interference prediction 615 AI/ML model, are depicted as arriving prior to the prediction, and transmission of a report 620 (e.g., a report of the results of interference prediction 615) is depicted after the prediction.

As shown in the example 600, there are three example methods of determining MPU occupancy time. MPU occupancy time A begins with the beginning of interference prediction 615 inference and ends when the interference prediction 615 ends. MPU occupancy time B begins when the last reference signal 610 before the interference prediction 615 is received and ends after the UE transmits the report 620 associated with the prediction. MPU occupancy time C begins when the first reference signal 610 is received and ends after the UE transmits the report 620.

As indicated above, FIG. 6 is provided as an example. Other examples may differ from what is described with respect to FIG. 6. For example, other events could be used to indicate the beginning and/or end of the MPU occupancy time. For other ML operations (e.g., other than interference prediction), the MPU occupancy time is likely to be different from the example 600 depicted in FIG. 6. The MPU occupancy time is designed to ensure that MPUs are allocated to a UE in a manner that ensures the maximum MPUs are not exceeded by simultaneous ML operations.

By the UE transmitting data indicating the number of MPUs associated with each ML operation as well as the maximum number effectively supported by the UE, and by the network node transmitting configuration information using the number of MPUs and the maximum number supported by the UE, the described techniques may enable the network to tailor the scheduling and configuration of ML operations. For example, this may enable the network to schedule ML operations within the UE's capabilities, which may reduce the likelihood of overburdening the UE and may optimize ML operations with respect to available computational, memory, and power resources. In this way, UEs may take advantage of advanced AI/ML techniques capable of improving network performance while conserving processing resources, memory resources, network resources, power resources, and/or the like.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with machine learning processing capability management.

As shown in FIG. 7, in some aspects, process 700 may include receiving configuration information indicating that the UE is to report a number of MPUs for each of a plurality of ML operations (block 710). For example, the UE (e.g., using reception component 902 and/or communication manager 906, depicted in FIG. 9) may receive configuration information indicating that the UE is to report a number of MPUs for each of a plurality of ML operations, as described above. In some aspects, the reception of the configuration information may be performed in a manner similar to reception of the configuration information 505 of FIG. 5.

As further shown in FIG. 7, in some aspects, process 700 may include transmitting data indicating the number of MPUs for each of the plurality of ML operations and a maximum number of MPUs supported by the UE (block 720). For example, the UE (e.g., using transmission component 904 and/or communication manager 906, depicted in FIG. 9) may transmit data indicating the number of MPUs for each of the plurality of ML operations and a maximum number of MPUs supported by the UE, as described above. In some aspects, the transmission of the data may be performed in a manner similar to transmission of the data 515 of FIG. 5.

Process 700 may include additional aspects, such as any single aspect or any combination of aspects described below and/or in connection with one or more other processes described elsewhere herein.

In a first aspect, the plurality of ML operations comprises ML operations associated with one or more of interference prediction, CSI prediction, CSI compression, beam prediction, positioning, sensing, scheduling, selection, or referencing signal design, e.g., as described in connection with FIG. 3 through FIG. 6.

In a second aspect, alone or in combination with the first aspect, at least one of the plurality of ML operations comprises a combination of two or more AI/ML model functionalities, e.g., as described in connection with FIG. 3 through FIG. 6.

In a third aspect, alone or in combination with one or more of the first and second aspects, at least two ML operations of the plurality of ML operations are associated with a same AI/ML model functionality and a different number of MPUs, e.g., as described in connection with FIG. 3 through FIG. 6.

In a fourth aspect, alone or in combination with one or more of the first through third aspects, a difference in the number of MPUs for the at least two ML operations that are associated with the same AI/ML model is based at least in part on a difference in an environment associated with the UE, e.g., as described in connection with FIG. 3 through FIG. 6.

In a fifth aspect, alone or in combination with one or more of the first through fourth aspects, for each of the plurality of ML operations, the number of MPUs is associated with at least one of an AI/ML model ID or an AI/ML model functionality, e.g., as described in connection with FIG. 3 through FIG. 6.

In a sixth aspect, alone or in combination with one or more of the first through fifth aspects, the data indicating the number of MPUs for each of the plurality of ML operations comprises data indicating the at least one of the AI/ML model ID or the AI/ML model functionality, e.g., as described in connection with FIG. 3 through FIG. 6.

In a seventh aspect, alone or in combination with one or more of the first through sixth aspects, process 700 includes receiving second configuration information indicating that the UE is to execute a subset of the plurality of ML operations without exceeding the maximum number of MPUs, e.g., as described in connection with FIG. 3 through FIG. 6.

In an eighth aspect, alone or in combination with one or more of the first through seventh aspects, process 700 includes executing a subset of the plurality of ML operations without exceeding the maximum number of MPUs, e.g., as described in connection with FIG. 3 through FIG. 6.

In a ninth aspect, alone or in combination with one or more of the first through eighth aspects, process 700 includes transmitting data indicating an MPU occupancy time associated with an ML operation of the plurality of ML operations, wherein the MPU occupancy time is defined by a temporal separation between an earliest input and a latest output associated with the ML operation, e.g., as described in connection with FIG. 3 through FIG. 6.

In a tenth aspect, alone or in combination with one or more of the first through ninth aspects, the latest output associated with the ML operation is at least one of an ML output of the ML operation, or transmission of data associated with the ML output of the ML operation, e.g., as described in connection with FIG. 3 through FIG. 6.

In an eleventh aspect, alone or in combination with one or more of the first through tenth aspects, the number of MPUs for at least one of the plurality of ML operations is based at least in part on an operational mode associated with the at least one of the plurality of ML operations, the operational mode comprising at least one of an inference operational mode associated with ML execution, a training operational mode associated with ML training, or a monitoring operational associated with analyzing ML results, e.g., as described in connection with FIG. 3 through FIG. 6.

In a twelfth aspect, alone or in combination with one or more of the first through eleventh aspects, the number of MPUs for each of the plurality of the ML operations is based at least in part on the operational mode, e.g., as described in connection with FIG. 3 through FIG. 6.

In a thirteenth aspect, alone or in combination with one or more of the first through twelfth aspects, process 700 includes identifying, for an ML operation of the plurality of ML operations, at least one of an input complexity value associated with input for the ML operation, or an output complexity value associated with output of the ML operation, and identifying the number of MPUs for the ML operation based at least in part on the input complexity value, the output complexity value, and a base complexity value for an AI/ML model used in the ML operation, e.g., as described in connection with FIG. 3 through FIG. 6.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with machine learning processing capability management.

As shown in FIG. 8, in some aspects, process 800 may include receiving data indicating a number of MPUs for each of a plurality of ML operations and a maximum number of MPUs supported by a UE (block 810). For example, the network node (e.g., using reception component 1002 and/or communication manager 1006, depicted in FIG. 10) may receive data indicating a number of MPUs for each of a plurality of ML operations and a maximum number of MPUs supported by a UE, as described above. In some aspects, the reception of the data may be performed in a manner similar to reception of the data 515 of FIG. 5.

As further shown in FIG. 8, in some aspects, process 800 may include transmitting configuration information indicating that the UE is to execute a subset of the plurality of ML operations, where the number of MPUs associated with the subset does not exceed the maximum number of MPUs (block 820). For example, the network node (e.g., using transmission component 1004 and/or communication manager 1006, depicted in FIG. 10) may transmit configuration information indicating that the UE is to execute a subset of the plurality of ML operations, wherein the number of MPUs associated with the subset does not exceed the maximum number of MPUs, as described above. In some aspects, the transmission of the configuration information may be performed in a manner similar to the transmission of the second configuration information 520 of FIG. 5. In some aspects, the number of MPUs associated with the subset does not exceed the maximum number of MPUs.

Process 800 may include additional aspects, such as any single aspect or any combination of aspects described below and/or in connection with one or more other processes described elsewhere herein.

In a first aspect, the plurality of ML operations comprises ML operations associated with one or more of interference prediction, CSI prediction, beam prediction, positioning, sensing, scheduling, selection, or referencing signal design, e.g., as described in connection with FIG. 3 through FIG. 6.

In a second aspect, alone or in combination with the first aspect, at least one of the plurality of ML operations comprises a combination of two or more AI/ML model functionalities, e.g., as described in connection with FIG. 3 through FIG. 6.

In a third aspect, alone or in combination with one or more of the first and second aspects, at least two ML operations of the plurality of ML operations are associated with a same AI/ML model functionality and a different number of MPUs, e.g., as described in connection with FIG. 3 through FIG. 6.

In a fourth aspect, alone or in combination with one or more of the first through third aspects, a difference in the number of MPUs for the at least two ML operations that are associated with the same AI/ML model is based at least in part on a difference in an environment associated with the UE, e.g., as described in connection with FIG. 3 through FIG. 6.

In a fifth aspect, alone or in combination with one or more of the first through fourth aspects, the number of MPUs is associated with at least one of an ML ID or an AI/ML model functionality, e.g., as described in connection with FIG. 3 through FIG. 6.

In a sixth aspect, alone or in combination with one or more of the first through fifth aspects, the data indicating the number of MPUs for each of the plurality of ML operations comprises data indicating the at least one of the AI/ML model ID or the AI/ML model functionality, e.g., as described in connection with FIG. 3 through FIG. 6.

In a seventh aspect, alone or in combination with one or more of the first through sixth aspects, process 800 includes receiving data indicating an MPU occupancy time associated with an ML operation of the plurality of ML operations, wherein the MPU occupancy time is defined by a temporal separation between an earliest input and a latest output associated with the ML operation, and wherein the subset is based at least in part on the MPU occupancy time, e.g., as described in connection with FIG. 3 through FIG. 6.

In an eighth aspect, alone or in combination with one or more of the first through seventh aspects, the latest output associated with the ML operation is at least one of an ML output of the ML operation, or transmission of data associated with the ML output of the ML operation, e.g., as described in connection with FIG. 3 through FIG. 6.

In a ninth aspect, alone or in combination with one or more of the first through eighth aspects, the subset is based at least in part on an operational mode associated with the at least one of the plurality of ML operations, the operational mode comprising at least one of an inference operational mode associated with ML execution, a training operational mode associated with ML training, or a monitoring operational associated with analyzing ML results, e.g., as described in connection with FIG. 3 through FIG. 6.

In a tenth aspect, alone or in combination with one or more of the first through ninth aspects, process 800 includes transmitting second configuration information indicating that the UE is to report the number of MPUs based at least in part on the operational mode, e.g., as described in connection with FIG. 3 through FIG. 6.

In an eleventh aspect, alone or in combination with one or more of the first through tenth aspects, the subset is based at least in part on an input complexity value, an output complexity value, and a base complexity value for an AI/ML model used in an ML operation associated with the subset, wherein the input complexity value is associated with input for the ML operation, and the output complexity value is associated with output of the ML operation, e.g., as described in connection with FIG. 3 through FIG. 6.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel, e.g., as described in connection with FIG. 3 through FIG. 6.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive configuration information indicating that the UE is to report a number of MPUs for each of a plurality of ML operations. The transmission component 904 may transmit data indicating the number of MPUs for each of the plurality of ML operations and a maximum number of MPUs supported by the UE.

The reception component 902 may receive second configuration information indicating that the UE is to execute a subset of the plurality of ML operations without exceeding the maximum number of MPUs.

The communication manager 906 may execute a subset of the plurality of ML operations without exceeding the maximum number of MPUs.

The transmission component 904 may transmit data indicating an MPU occupancy time associated with an ML operation of the plurality of ML operations wherein the MPU occupancy time is defined by a temporal separation between an earliest input and a latest output associated with the ML operation.

The communication manager 906 may identify, for an ML operation of the plurality of ML operations, at least one of an input complexity value associated with input for the ML operation, or an output complexity value associated with output of the ML operation.

The communication manager 906 may identify the number of MPUs for the ML operation based at least in part on the input complexity value, the output complexity value, and a base complexity value for an AI/ML model used in the ML operation.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive data indicating a number of MPUs for each of a plurality of ML operations and a maximum number of MPUs supported by a UE. The transmission component 1004 may transmit configuration information indicating that the UE is to execute a subset of the plurality of ML operations wherein the number of MPUs associated with the subset does not exceed the maximum number of MPUs.

The reception component 1002 may receive data indicating an MPU occupancy time associated with an ML operation of the plurality of ML operations wherein the MPU occupancy time is defined by a temporal separation between an earliest input and a latest output associated with the ML operation, and wherein the subset is based at least in part on the MPU occupancy time.

The transmission component 1004 may transmit second configuration information indicating that the UE is to report the number of MPUs based at least in part on the operational mode.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: receiving configuration information indicating that the UE is to report a number of MPUs for each of a plurality of ML operations; and transmitting data indicating the number of MPUs for each of the plurality of ML operations and a maximum number of MPUs supported by the UE.

Aspect 2: The method of Aspect 1, wherein the plurality of ML operations comprises ML operations associated with one or more of: interference prediction, CSI prediction, CSI compression, beam prediction, positioning, sensing, scheduling, resource selection, or reference signal design.

Aspect 3: The method of any of Aspects 1-2, wherein at least one of the plurality of ML operations comprises a combination of two or more AI/ML model functionalities.

Aspect 4: The method of any of Aspects 1-3, wherein at least two ML operations of the plurality of ML operations are associated with a same AI/ML model functionality and a different number of MPUs.

Aspect 5: The method of Aspect 4, wherein a difference in the number of MPUs for the at least two ML operations that are associated with the same AI/ML model is based at least in part on a difference in an environment associated with the UE.

Aspect 6: The method of any of Aspects 1-5, wherein, for each of the plurality of ML operations, the number of MPUs is associated with at least one of an AI/ML model ID or an AI/ML model functionality.

Aspect 7: The method of Aspect 6, wherein the data indicating the number of MPUs for each of the plurality of ML operations comprises data indicating the at least one of the AI/ML model ID or the AI/ML model functionality.

Aspect 8: The method of any of Aspects1-7, further comprising: receiving second configuration information indicating that the UE is to execute a subset of the plurality of ML operations without exceeding the maximum number of MPUs.

Aspect 9: The method of any of Aspects 1-8, further comprising: executing a subset of the plurality of ML operations without exceeding the maximum number of MPUs.

Aspect 10: The method of any of Aspects 1-9, further comprising: transmitting data indicating an MPU occupancy time associated with an ML operation of the plurality of ML operations, wherein the MPU occupancy time is defined by a temporal separation between an earliest input and a latest output associated with the ML operation.

Aspect 11: The method of Aspect 10, wherein the latest output associated with the ML operation is at least one of: an ML output of the ML operation, or transmission of data associated with the ML output of the ML operation.

Aspect 12: The method of any of Aspects 1-11, wherein the number of MPUs for at least one of the plurality of ML operations is based at least in part on an operational mode associated with the at least one of the plurality of ML operations, the operational mode comprising at least one of: an inference operational mode associated with ML execution, a training operational mode associated with ML training, or a monitoring operational associated with analyzing ML results.

Aspect 13: The method of Aspect 12, wherein the number of MPUs for each of the plurality of the ML operations is based at least in part on the operational mode.

Aspect 14: The method of any of Aspects 1-13, further comprising: identifying, for an ML operation of the plurality of ML operations, at least one of: an input complexity value associated with input for the ML operation, or an output complexity value associated with output of the ML operation; and identifying the number of MPUs for the ML operation based at least in part on the input complexity value, the output complexity value, and a base complexity value for an AI/ML model used in the ML operation.

Aspect 15: A method of wireless communication performed by a network node, comprising: receiving data indicating a number of MPUs for each of a plurality of ML operations and a maximum number of MPUs supported by a UE; and transmitting configuration information indicating that the UE is to execute a subset of the plurality of ML operations, wherein the number of MPUs associated with the subset does not exceed the maximum number of MPUs.

Aspect 16: The method of Aspect 15, wherein the plurality of ML operations comprises ML operations associated with one or more of: interference prediction, CSI prediction, CSI compression, beam prediction, positioning, sensing, scheduling, resource selection, or reference signal design.

Aspect 17: The method of any of Aspects 15-16, wherein at least one of the plurality of ML operations comprises a combination of two or more AI/ML model functionalities.

Aspect 18: The method of any of Aspects 15-17, wherein at least two ML operations of the plurality of ML operations are associated with a same AI/ML model functionality and a different number of MPUs.

Aspect 19: The method of Aspect 18, wherein a difference in the number of MPUs for the at least two ML operations that are associated with the same AI/ML model is based at least in part on a difference in an environment associated with the UE.

Aspect 20: The method of any of Aspects 15-19, for each of the plurality of ML operations, the number of MPUs is associated with at least one of an AI/ML model ID or an AI/ML model functionality.

Aspect 21: The method of Aspect 20, wherein the data indicating the number of MPUs for each of the plurality of ML operations comprises data indicating the at least one of the AI/ML model ID or the AI/ML model functionality.

Aspect 22: The method of any of Aspects 15-21, further comprising: receiving data indicating an MPU occupancy time associated with an ML operation of the plurality of ML operations, wherein the MPU occupancy time is defined by a temporal separation between an earliest input and a latest output associated with the ML operation, and wherein the subset is based at least in part on the MPU occupancy time.

Aspect 23: The method of Aspect 22, wherein the latest output associated with the ML operation is at least one of: an ML output of the ML operation, or transmission of data associated with the ML output of the ML operation.

Aspect 24: The method of any of Aspects 15-23, wherein the subset is based at least in part on an operational mode associated with the at least one of the plurality of ML operations, the operational mode comprising at least one of: an inference operational mode associated with ML execution, a training operational mode associated with ML training, or a monitoring operational associated with analyzing ML results.

Aspect 25: The method of Aspect 24, further comprising: transmitting second configuration information indicating that the UE is to report the number of MPUs based at least in part on the operational mode.

Aspect 26: The method of any of Aspects 15-25, wherein the subset is based at least in part on an input complexity value, an output complexity value, and a base complexity value for an AI/ML model used in an ML operation associated with the subset, wherein the input complexity value is associated with input for the ML operation, and the output complexity value is associated with output of the ML operation.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled to the one or more memories, the one or more processors individually or collectively configured to:
receive configuration information indicating that the UE is to report a number of machine learning processing units (MPUs) for each of a plurality of machine learning (ML) operations; and
transmit data indicating the number of MPUs for each of the plurality of ML operations and a maximum number of MPUs supported by the UE.

2. The UE of claim 1, wherein the plurality of ML operations comprises ML operations associated with one or more of:
interference prediction,
channel state information (CSI) prediction,
CSI compression,
beam prediction,
positioning,
sensing,
scheduling,
resource selection, or
reference signal design.

3. The UE of claim 1, wherein at least one of the plurality of ML operations comprises a combination of two or more AI/ML model functionalities.

4. The UE of claim 1, wherein at least two ML operations of the plurality of ML operations are associated with a same AI/ML model functionality and a different number of MPUs.

5. The UE of claim 1, wherein, for each of the plurality of ML operations, the number of MPUs is associated with at least one of an AI/ML model identifier (ID) or an AI/ML model functionality.

6. The UE of claim 1, wherein the one or more processors are further individually or collectively configured to:
receive second configuration information indicating that the UE is to execute a subset of the plurality of ML operations without exceeding the maximum number of MPUs.

7. The UE of claim 1, wherein the one or more processors are further individually or collectively configured to:
execute a subset of the plurality of ML operations without exceeding the maximum number of MPUs.

8. The UE of claim 1, wherein the one or more processors are further individually or collectively configured to:
transmit data indicating an MPU occupancy time associated with an ML operation of the plurality of ML operations,
wherein the MPU occupancy time is defined by a temporal separation between an earliest input and a latest output associated with the ML operation.

9. The UE of claim 8, wherein the latest output associated with the ML operation is at least one of:
an ML output of the ML operation, or
transmission of data associated with the ML output of the ML operation.

10. The UE of claim 1, wherein the number of MPUs for at least one of the plurality of ML operations is based at least in part on an operational mode associated with the at least one of the plurality of ML operations, the operational mode comprising at least one of:
an inference operational mode associated with ML execution,
a training operational mode associated with ML training, or
a monitoring operational associated with analyzing ML results.

11. The UE of claim 1, wherein the one or more processors are further individually or collectively configured to:
identify, for an ML operation of the plurality of ML operations, at least one of:
an input complexity value associated with input for the ML operation, or
an output complexity value associated with output of the ML operation; and
identify the number of MPUs for the ML operation based at least in part on the input complexity value, the output complexity value, and a base complexity value for an AI/ML model used in the ML operation.

12. A network node for wireless communication, comprising:
one or more memories; and
one or more processors coupled to the one or more memories, the one or more processors individually or collectively configured to:
receive data indicating a number of machine learning processing units (MPUs) for each of a plurality of machine learning (ML) operations and a maximum number of MPUs supported by a user equipment (UE); and
transmit configuration information indicating that the UE is to execute a subset of the plurality of ML operations,
wherein the number of MPUs associated with the subset does not exceed the maximum number of MPUs.

13. The network node of claim 12, wherein the plurality of ML operations comprises ML operations associated with one or more of:
interference prediction,
channel state information (CSI) prediction,
CSI compression,
beam prediction,
positioning,
sensing,
scheduling,
resource selection, or
reference signal design.

14. The network node of claim 12, for each of the plurality of ML operations, the number of MPUs is associated with at least one of an AI/ML model identifier (ID) or an AI/ML model functionality.

15. The network node of claim 12, wherein the one or more processors are further individually or collectively configured to:
receive data indicating an MPU occupancy time associated with an ML operation of the plurality of ML operations,
wherein the MPU occupancy time is defined by a temporal separation between an earliest input and a latest output associated with the ML operation, and
wherein the subset is based at least in part on the MPU occupancy time.

16. The network node of claim 15, wherein the latest output associated with the ML operation is at least one of:
an ML output of the ML operation, or
transmission of data associated with the ML output of the ML operation.

17. The network node of claim 12, wherein the subset is based at least in part on an operational mode associated with the at least one of the plurality of ML operations, the operational mode comprising at least one of:
an inference operational mode associated with ML execution,
a training operational mode associated with ML training, or
a monitoring operational associated with analyzing ML results.

18. The network node of claim 17, wherein the one or more processors are further individually or collectively configured to:
transmit second configuration information indicating that the UE is to report the number of MPUs based at least in part on the operational mode.

19. The network node of claim 12, wherein the subset is based at least in part on an input complexity value, an output complexity value, and a base complexity value for an AI/ML model used in an ML operation associated with the subset,
wherein the input complexity value is associated with input for the ML operation, and the output complexity value is associated with output of the ML operation.

20. A method of wireless communication performed by user equipment (UE), comprising:
receiving configuration information indicating that the UE is to report a number of machine learning processing units (MPUs) for each of a plurality of machine learning (ML) operations; and
transmitting data indicating the number of MPUs for each of the plurality of ML operations and a maximum number of MPUs supported by the UE.
